(19) United States
(12) Patent Application Publication
(10) Pub. No.: US 2022/0107714 A1
(43) Pub. Date: Apr. 7, 2022

(54) SYSTEM AND METHOD FOR GENERATING AND SYNCHRONOUSLY EXECUTING A MULTIPLAYER SCENARIO IN ONE OF A VIRTUAL, MIXED AND AUGMENTED REALITY ENVIRONMENT

(71) Applicant: OVA Inc., Quêbec (CA)

(72) Inventors: Harold Dumur, Québec (CA); Lucie Rivard, Québec (CA); Pierre-Luc LaPointe, Québec (CA); Sijia Mao, Québec (CA); Axel Berneron, Québec (CA); Marek Tremblay, Québec (CA); Isabelle Chum-Chhin, Québec (CA); Simon Pigot, Québec (CA); Benjamin Drouin, Québec (CA); Nolan Bublex, Québec (CA); Jean-François Couture, Québec (CA); Keith Beaudoin, Québec (CA)

(21) Appl. No.: 17/236,039

(22) Filed: Apr. 21, 2021

Related U.S. Application Data
(60) Provisional application No. 63/088,182, filed on Oct. 6, 2020.

(30) Foreign Application Priority Data
Jan. 25, 2021 (CA) 3106927

(51) Int. Cl. G06F 3/0484; G06F 3/14; G06T 19/00; G06F 3/0481; H04L 29/08; G06F 9/54; G06F 8/34

(52) U.S. Cl. CPC G06F 3/0484; G06F 3/1454; G06T 19/00; G06F 3/0481; G06T 2200/24; H04L 67/1095; G06F 9/547; G06F 8/34; G06T 2219/024; H04L 67/141

(57) ABSTRACT

A system for generating and synchronously executing a multiplayer scenario, in one of a virtual, mixed and augmented reality environment and having a visual programming module allowing generation and management of at least one of an asset of a scenario and a visual acyclic relation action graph defined by a plurality of nodes and a network module configured to connect a plurality of clients over a network for synchronized execution of the nodes of the acyclic relation action graph. The network module operates using a network protocol including an identity component including a unique asset identifier and an asset container for each asset of the scenario and being replicable on the plurality of clients; and a node component defining a unique node identifier and a node container for each node of the visual acyclic relation action graph and being replicable on the plurality of clients.

### TECHNICAL FIELD OF THE INVENTION

The present invention relates to the field of virtual, mixed and augmented reality scenarios. More particularly, it relates to a system and a method for generating a visual acyclic relation action graph defining a scenario in one of the virtual, mixed and augmented reality environment and to synchronously execute the scenario for a plurality of clients being part of a session, over a network.

### BACKGROUND

There is known in the art multimodal graphic or visual programming language tool which allows non-programmers (i.e. users without programming knowledge) to create computer programs using visual tools. Such tools can for example allow creation of computer programs using programming tools based on tree representations of the abstract syntax tree (AST) of the source code, where the computer program is generated by an assembly of graphic elements composed of graphical symbols, icons and texts arranged spatially on a plane or on a canvas created by a user, with each one of the graphical symbols, icons or text being used to define an input, an action, a connection and/or an output defining the program logic. Hence such tools allow computer programs to be generated, by users arranging the graphical symbols, icons and texts using a graphical user interface and without having to write code lines.

Known systems and methods for providing multimodal graphic or visual programming language tools, however, tend to suffer from several drawbacks. For example, few multimodal graphic or visual programming language tools are configured to allow visual programming for the creation and management of assets in one of a virtual, mixed or augmented reality environment and/or the creation or management of visual acyclic relation action graphs defining a scenario for virtual, mixed or augmented reality environment. Moreover, known systems and methods for providing multimodal graphic or visual programming language tools allowing such visual programming for the creation or management of assets or visual acyclic relation action graphs defining a scenario for virtual, mixed or augmented reality environment have limited capabilities or deficiencies limiting the synchronization of the scenario defined by the visual acyclic relation action graph over a network, for a plurality of clients being part of a session.

In view of the above, there is a need for a system and a method for generating and synchronously executing a multiplayer scenario, in one of a virtual, mixed and augmented reality environment which, by virtue of its design and/or components, would be able to overcome or at least minimize some of the above-discussed prior art concerns.

### SUMMARY OF THE INVENTION

In accordance with a first general aspect, there is provided a system for generating and synchronously executing a multiplayer scenario, in one of a virtual, mixed and augmented reality environment. The system comprises: a visual programming module including a graphical user interface allowing generation and management of at least one of an asset of a scenario and a visual acyclic relation action graph defined by a plurality of nodes, the at least one of the asset and the visual acyclic relation action graph being generated and managed in response to user inputs received from an input device of a computing device displaying the graphical user interface, the visual acyclic relation action graph defining the multiplayer scenarios in the one of the virtual, mixed and augmented reality environment; and a network module configured to connect a plurality of clients over a network for synchronized execution of the nodes of the acyclic relation action graph on the plurality of clients. The network module operates using a network protocol comprising: an identity component including a unique asset identifier and an asset container for each asset of the multiplayer scenario requiring replication on the plurality of clients for synchronized execution of the scenario thereon, the unique asset identifier being associated to the corresponding asset for an entire session, the asset container storing boxed objects defining the data regarding the position, rotation and properties of the asset, the identity component being replicable on the plurality of clients; and a node component defining a unique node identifier and a node container for each node of the visual acyclic relation action graph which also requires replication on the plurality of clients for synchronized execution of the scenario thereon, the unique node identifier being associated to the node for the entire session, the node container storing boxed objects containing the node data defining the state of the node, the node component being replicable on the plurality of clients.

In an embodiment, the identity component further includes an authority identifier identifying which one of the clients currently has control of the asset within the scenario being executed.

In an embodiment, the network module is implemented using a network communication server in data communication with each one of the plurality of clients over the network in a client-server architecture.

In an embodiment, each one of the plurality of clients has stored in a memory thereof a virtual, mixed or augmented reality application configured to execute the scenario in the one of the virtual, mixed or augmented reality environment.

In an embodiment, the node data from the node component of each node is imported into the corresponding node executed in the virtual, mixed or augmented reality application, each node processing the node data corresponding therewith in accordance with a specific operation of the node.

In an embodiment, the network communication server communicates data via a network server application programming interface and the virtual reality, mixed or augmented reality application stored in the memory of each client communicates data via a client application programming interface.

In an embodiment, the network module and the network protocol thereof are configured to allow the synchronized execution of the scenario on the plurality of clients connected via each one of an offline network and an online network.

In an embodiment, the visual acyclic relation action graph comprises a plurality of visual acyclic relation action subgraphs, the system allowing at least a subset of the plurality of visual acyclic relation action subgraphs to be executed simultaneously.

In accordance with another general aspect, there is also provided a computer implemented method for generating and synchronously executing a multiplayer scenario, in one of a virtual, mixed and augmented reality environment. The method comprises the steps of: receiving user inputs relative to management of at least one of an asset of the multiplayer scenario and a visual acyclic relation action graph defined by a plurality of nodes and being performed on a graphical user interface using visual programming, the visual acyclic relation action graph defining the multiplayer scenarios in the one of the virtual, mixed and augmented reality environment; generating and managing the visual acyclic relation action graph comprising the nodes, in accordance with the received user inputs; and connecting a plurality of clients over a network and synchronizing the execution of the nodes of the relation action graph on the plurality of clients. This step includes the sub steps of: generating identity components each including a unique asset identifier and an asset container for an asset of the multiplayer scenario requiring replication on the plurality of clients for synchronized execution of the scenario thereon, the unique asset identifier being associated to the corresponding asset for an entire session and the asset container storing boxed objects defining the data regarding the position, rotation and properties of the asset; generating node components each defining a unique node identifier and a node container for a node of the visual acyclic relation action graph which also requires replication on the plurality of clients for synchronized execution of the scenario thereon, the unique node identifier being associated to the node for the entire session, the node container storing boxed objects containing the node data defining the state of the node; replicating at least a corresponding one of the identity components and node components onto each one of the plurality of clients, upon occurrence of a change in a state of an asset or a node in the execution of the scenario on one of the clients; and refreshing the state of the corresponding one of the asset or the node on the plurality of clients using the data from the boxed objects of the replicated corresponding one of the identity components and node components.

In an embodiment, the identity components each further include an authority identifier identifying the client currently having control of the asset within the execution of the scenario being executed. The step of replicating at least a corresponding one of the identity components and node components onto each one of the plurality of clients, upon occurrence of a change in a state of an asset or a node in the execution of the scenario on one of the clients comprises replicating the identity components of the client being identified as having control of the asset within the scenario onto the other clients, upon occurrence of a change in the state of the asset in the execution of the scenario on the client currently having control of the asset within the scenario.

In an embodiment, the method further comprises the step of executing the scenario in the one of the virtual, mixed or augmented reality environment for each one of the clients using a virtual, mixed or augmented reality application stored in a memory thereof and using the data from the replicated identity components and the node components for execution of the scenario.

In an embodiment, the node data from the node components is imported into the corresponding nodes executed in the virtual, mixed or augmented reality application and the method comprises the step of processing the node data corresponding therewith in accordance with operation of the specific node.

In an embodiment, the step of replicating at least a corresponding one of the identity components and node components onto each one of the plurality of clients, upon occurrence of a change in a state of an asset or a node in the execution of the scenario on one of the clients comprises transmitting the container of the corresponding one of the identity components and node components on the network and forwarding the container to every clients.

In an embodiment, the step of connecting a plurality of clients over a network and synchronizing the execution of the nodes of the relation action graph on the plurality of clients comprises allowing data communication between the plurality of clients and a network communication server over a network via each one of an offline network and an online network.

In accordance with another general aspect, there is further provided a non-transitory computer-readable medium having instructions stored thereon that, when executed by a processor, perform the steps of the method as described above.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIG. 1 is a schematic representation of a system for generating and synchronously executing a multiplayer scenario, in one of a virtual, mixed and augmented reality environment, in accordance with an embodiment.

FIG. 2 is a schematic representation of an acyclic relation action graph in accordance with an embodiment.

FIG. 3 is a schematic representation of the components of the network module, or components operating in combination therewith, to allow the synchronized execution of nodes on a plurality of clients connected thereto, in accordance with an embodiment

FIG. 4 is a flowchart showing the steps of a method for generating and synchronously executing a multiplayer scenario, in one of a virtual, mixed and augmented reality environment, in accordance with an embodiment.

### DETAILED DESCRIPTION

In the following description, the same numerical references refer to similar elements. The embodiments and alternatives shown in the figures or described in the present description are embodiments only, given solely for exemplification purposes.

Moreover, although the embodiments of the system for generating and synchronously executing a multiplayer scenario, in one of a virtual, mixed and augmented reality environment and corresponding parts thereof consist of certain elements and configurations as explained and illustrated herein, not all of these components are essential and thus should not be taken in their restrictive sense. It is to be understood, as also apparent to a person skilled in the art, that other suitable components and cooperation thereinbetween, may be used for the system for generating and synchronously executing a multiplayer scenario, in one of a virtual, mixed and augmented reality environment, as will be briefly explained herein and as can be easily inferred herefrom by a person skilled in the art.

Moreover, although the associated method includes steps as explained and illustrated herein, not all of these steps are essential and thus should not be taken in their restrictive sense. It will be appreciated that the steps of the method for generating and synchronously executing a multiplayer scenario, in one of a virtual, mixed and augmented reality environment described herein may be performed in the described order, or in any suitable order.

The term “computing device” is used below to encompasses computers, servers and/or specialized electronic devices which receive, process and/or transmit data. “Computing devices” are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or trading data to be processed. Storage medium encompasses volatile or non-volatile/persistent memory, such as registers, cache, RAM, flash memory, ROM, as examples only. The type of memory is chosen according to the desired use, whether it should retain instructions, or temporarily store, retain or update data. Steps of the proposed method are implemented as software instructions and algorithms, stored in computer memory and executed by processors. It should be understood that servers and computers are required to implement the proposed system, and to execute the proposed method.

In the course of the present description, the term “network” is used to refer to any network, which includes publicly accessible networks of linked networks, possibly operated by various distinct parties, such as the Internet, private networks, personal area networks, local area networks, wide area networks, cable networks, satellite networks, cellular telephone networks, etc. or combination thereof. The term “offline network”, is used to refer to an internal network where a limited amount of connected devices are connected with one another, with no external communication link, such as, for example, a Personal Area Network or a Local Area Network having no Internet connection. In contrast, the term “online network” is used to refer to a global network such as the Internet having numerous interconnected networks and generally operating in a decentralized manner.

The term “asset” is used to define one of a 3D model being a mathematical representation of a three-dimensional object (animate or inanimate) and a media component used in a scenario. A 3D model is defined by a mathematical representation of the surfaces defining the object in three dimensions, which can be displayed in a virtual, mixed and/or augmented reality environment through graphics being a three-dimensional representation of the geometric data thereof. A media component can be one of an audible component, a textual component or a graphical element. An audible component is a sound clip allowing sound to be played in the virtual, mixed and/or augmented reality environment, A textual component is a text displayed in the virtual, mixed and/or augmented reality environment, for example and without being limitative, through a signage, text boxes, chat bubble, etc. A graphical element is one of an image or a video which can be displayed in the virtual, mixed and/or augmented reality environment.

The term “scenario” is used to represent a series or sequence of events experienced within a given space of a virtual, mixed and augmented reality environment, with each “space” being a virtual realm (or environment) that can be created and customized.

The term “client” is used to refer to a client computing device (or a specific component of computer hardware or software of the client computing device—or combination thereof) being used by a user for joining a live session, where a plurality of clients are in data communication and the scenario is executed synchronously, on each one of the plurality of client computing devices. One skilled in the art will understand that, in an embodiment, each one of the clients can contribute to the execution of a scenario, with the impacts of the actions of each client on the execution of the scenario being replicated to the other clients synchronously. The client computing device associated to each client, receives input data and sends request data to a server of the client-server architecture, which subsequently broadcasts the information to all of the client computing devices associated to the clients having joined the live session, to allow the synchronized execution of the multiplayer scenario for all of the clients.

The term “session” is used to define a temporary data communication between at least two clients.

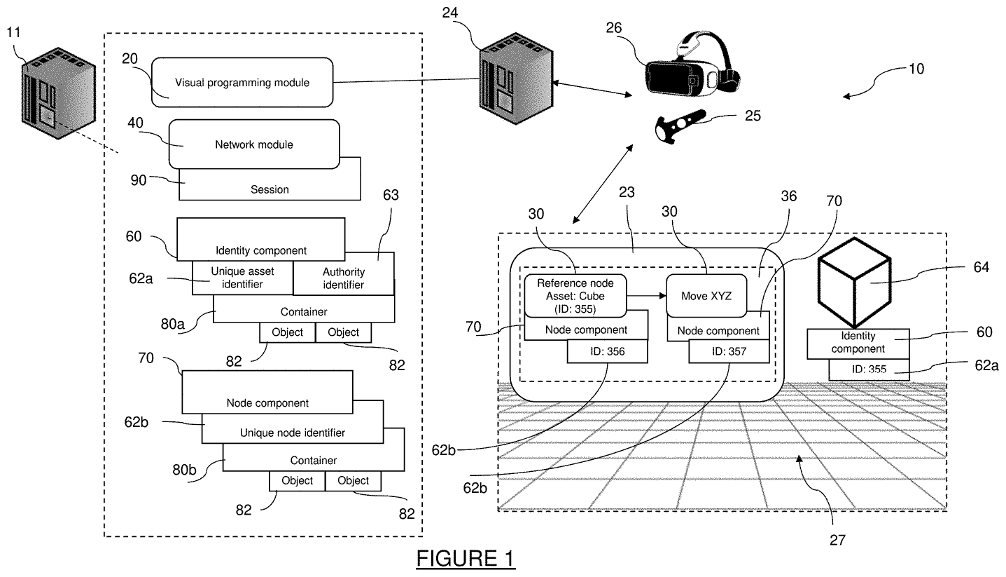

Referring generally to FIG. 1, there is shown a schematic representation of the system 10 for generating and synchronously executing a multiplayer scenario, in the one of the virtual, mixed and augmented reality environment, in accordance with an embodiment. As will be described in more details below, the system 10 is designed and configured to perform real-time (or near real-time), synchronous execution of multimodal logic at runtime, on a plurality of clients 50, in a client-server architecture.

The system 10 includes one or more system computing devices 11 such as for example and without being limitative, servers, and data storage, having stored in a memory thereof a visual programming module 20 allowing graphical programming for creating and managing an asset 64 of a scenario in the space 27 of the one of the virtual, mixed and augmented reality environment and/or a visual acyclic relation action graph 36 defining the multiplayer scenario in the one of the virtual, mixed and augmented reality environment. The system 10 also includes a network module 40 (or synchronization module) stored in a memory of the one or more system computing devices 11, for connecting the plurality of clients 50 over a network 44 and performing a synchronized execution of the multiplayer scenario on the plurality of clients 50. As can be appreciated, each one of the visual programming module 20 and the network module 40 can be implemented via programmable computer components, such as one or more physical or virtual computers comprising a processor and memory. It is appreciated, however, that other configurations are possible.

The visual programming module 20 includes a graphical user interface (GUI) 22 accessible by a user on a display of a user computing device 24 and allowing interaction with the user through user inputs received from one or more input devices 25 of the user computing device 24. For example and without being limitative, in an embodiment, the display can be the display of a virtual reality headset 26 and the input devices 25 can be virtual reality input devices such as a joysticks, a force Balls/Tracking balls, a controller wands, data gloves, trackpads, motion trackers, etc.

The GUI 22 includes visual controls which can be used by the user using the input devices 25 of the user computing device 24, to allow the creation and edition (management) of the assets 64 of a space 27 and/or the scenario to be enacted in the space 27. In other words, the GUI 22 allows the user to create and/or manage (i.e. edit) the assets 64 and/or the visual acyclic relation action graph 36 defining the scenario or a scene thereof, by graphical (or visual) programming (i.e. by providing data inputs relative to the arrangement of graphical symbols, icons and/or texts spatially on a plane, with each one of the graphical symbols, icons or text being used to define an input, an action, a connections and/or an output defining the program logic).

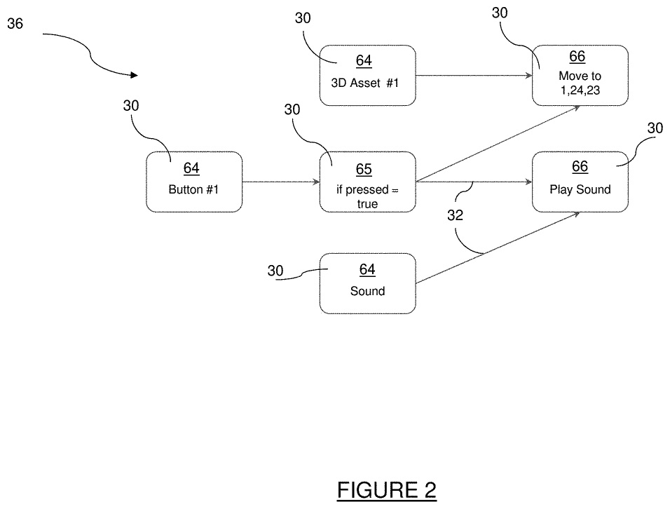

Referring to FIGS. 1 and 2, an acyclic relation action graph 36 is an oriented structure comprising a plurality of nodes 30, where pairs of nodes 30 are connected to one another, but without forming cycles (i.e. loops). The acyclic relation action graph 36 includes the data relative to each node 30 of the graph and the connections therebetween (i.e. the relation between the nodes). In other words, the acyclic relation action graph 36 includes the definition and information of each node 30 as well as the input and output value thereof. When executed, the acyclic relation action graph 36, defines the scenario or a scene thereof.

It will be understood that the system 10 can also execute acyclic relation action subgraphs (not shown), such that, in an embodiment, a scenario or a scene can be defined by a plurality of acyclic relation action subgraphs. In an embodiment, the system 10 can also allow the execution of multiple acyclic relation action graphs 36 and/or acyclic relation action subgraphs (not shown) simultaneously. In the remainder of the description below, only references to acyclic relation action graphs 36 will be made, but one skilled in the art will understand that any reference to an action graph 36 can also include a reference to an action subgraph 36.

Each node 30 of the acyclic relation action graph 36 can represent one of an asset 64, a condition 65 or an operation (action) 66 in the scenario (i.e. they can correspond to one of a mathematical operation or a value). The nodes 30 are key scenario-building concepts which, when linked to one another, create sequences and trigger contextually responsive events that are based on player interactions and temporal elements in the scenario. The creation and edition of the nodes 30 by a creator (i.e. user creating a scenario) therefore allows the creator to define specific rulesets within a space 27 and time of a scenario. In view of the above, using the GUI 22, interactive nodes 30 can be associated with interactive scene assets 64 and then linked together to define a multiplayer interactive action scenario.

One skilled in the art will understand that, even though nodes 30 of the acyclic relation action graph 36 can represent an asset 64, there is a distinction between the asset 64 of the scenario being displayed in the space 27 (and which can be created and edited using the GUI 22), and the nodes 30 of the acyclic relation action graph 36 identifying the asset 64.

Each node 30 can include one or more input and/or output port used to propagate a value, identify an asset 64 and/or indicate the directional flow of the acyclic relation action graphs 36. The nodes 30 are connected to one another by edges 32 connecting the ports thereof. A node 30 can be of different types defining the operation of the node 30. For example and without being limitative, the nodes 30 can be either: a reference node used to identify assets 64 in the space 27 within the scenario; an information node operating as information vessel and used to parametrize features within the space 27 (e.g. an audio node used to parametrize audio settings, an approximate number node containing a target approximation, an animation node used to animate assets 64 within the space 27); a conditional node used to offset specific behaviors in specific contexts based on temporal elements and player interactions (e.g. “If” node allowing users to branch off based on true or false values, “When” node allowing users to trigger action or event based on a given interaction or occurrence within the space 27, or “Until” node allowing users to trigger action or event based on a given interaction or occurrence within the space 27); or an action node allowing specific actions to occur within a space based on a specific context (e.g. “Snap” used to snap items together, “Unsnap” used to unsnap items previously snapped together, “Trigger” used to offset a trigger, “Untrigger” used to detect that the trigger is no longer activated. “Play” used to play an asset 64 being a media component, “Stop” used to stop the asset 64 being the media component from being played, or “Move” used to move an asset 64).

In an embodiment, using the GUI 22 of the visual programming module 20, creators can either create or manage nodes 30 of the acyclic relation action graph 36 or create or manage the properties of an asset 64 directly in the space 27. Therefore, the GUI 22 of the visual programming module 20 can display a space 27 with controls for receiving user inputs from the one or more input devices 25 of the user computing device 24 relative to asset management (i.e. relative to management of the asset 64 within the space 27, such as creation of an asset 64, deletion of an asset 64, edition of an asset 64 (i.e. modification of the parameters or values of the asset 64)). In an embodiment, the GUI 22 of the visual programming module 20 can also display a space 27 with controls for receiving user inputs from the one or more input devices 25 of the user computing device 24 relative to management of other aspects of the scenario, such as actions, conditions, etc. In an embodiment, the user inputs relative to asset or scenario management can be provided using drag-and-drop functionalities. The visual programming module 20 is configured to generate or update the acyclic relation action graph 36 in accordance with the management of the assets 64 or the scenario performed within the space 27 using the GUI 22.

In an embodiment, the GUI 22 also allows direct editing of the acyclic relation action graph 36 within a canvas 23 presenting the acyclic relation action graph 36 (i.e. editing of the nodes 30 or node connection defining the acyclic relation action graph 36). In an embodiment the canvas 23 is opened as an additional dimension in a space 27 (either in 2D or 3D) in which the creator can create or update the acyclic relation action graphs 36 defining the interactive and immersive scenario by managing nodes (i.e. modification of the parameters or values of the node) or a connection of a node 30 (i.e. creation or deletion of an edge between connecting ports of nodes 30). In such an embodiment, the GUI 22 of the visual programming module 20 displays the canvas 23 presenting the acyclic relation action graph 36 and receives user inputs relative to node management (i.e. relative to management of the node 30, such as creation of node, deletion of a node 30, edition of a node (i.e. modification of the parameters of a node 30 or of the relation (edges connecting the ports) of a pair of nodes 30)). In an embodiment, the user inputs relative to node management can be provided using drag-and-drop functionalities. In response to the user inputs generated by the creator using the input devices 25, the visual programming module 20 updates the acyclic relation action graphs 36 accordingly.

In the embodiment shown in FIG. 1, a GUI 22 of the visual programming module 20 is shown in a 3D environment (i.e. virtual, mixed or augmented reality environment) to be displayed on a virtual reality headset 26 and controlled with virtual reality controllers 25 as input devices. One skilled in the art will however understand that, in an alternative embodiment (not shown), the GUI 22 of the visual programming module 20 can be displayed in a 2D environment (e.g. be displayed on a 2D display monitor) and be controlled via a keyboard, a mouse, a trackpad or the like as input devices 25.

The network module 40 is configured to allow the scenario defined by the acyclic relation action graphs 36 to be executed and synchronized on a plurality of clients 50, in a multiplayer mode. In order to do so, the network module 40 operates using a specific network protocol designed to allow replication of the data relative to the nodes 30 on the plurality of clients 50, for synchronization thereof.

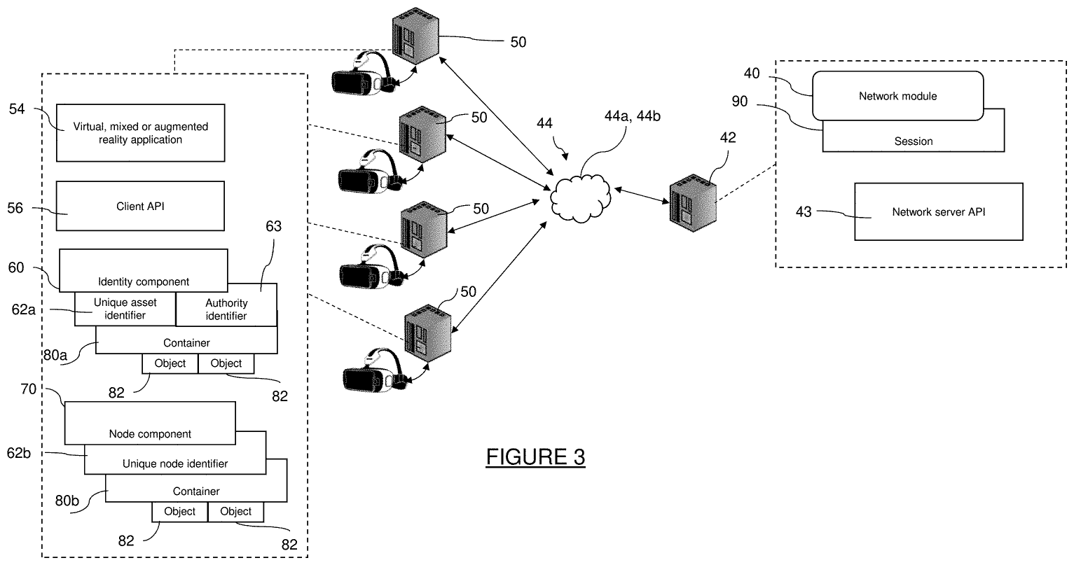

Referring to FIG. 3, the network module 40 and the network protocol thereof, allow the synchronized execution of the nodes 30 of the acyclic relation action graphs 36 generated using the visual programming module 20, for a plurality of clients 50 connected to one another via a network being either an offline network 44a or an online network 44b.

In the embodiment shown, the network module 40 is embodied through a combination of a network communication server 42 being in data communication with each one of the plurality of clients 50 over the network 44, in a client-server architecture.

Each one of the clients 50 has stored in a memory thereof a virtual, mixed or augmented reality application 54 comprising a set of instructions to execute a scenario in the one of the virtual, mixed or augmented reality environment.

In an embodiment, the network communication server 42 and the virtual, mixed or augmented reality application 54 are in data communication using a combination of a network server application programming interface (API) 43 of the network communication server 42 and a client application programming interface (API) 56 of the client 50. Each one of the network server API 43 and the client API 56 includes the set of programming code enabling data transmission between the network communication server 42 and the clients 50, and the terms of the data exchange therebetween.

In order to perform synchronization and execution of a scenario in multiplayer mode (i.e. for multiple clients 50 simultaneously), the network protocol of the network module 40 uses a combination of identity components 60, node components 70 and containers 80, which together allow the above-mentioned synchronized execution of the scenario defined by the acyclic relation action graphs 36 on the plurality of clients 50 (i.e. the synchronized execution of the nodes executed on the virtual, mixed or augmented reality application 54 of each client to carry out the scenario synchronously on the plurality of client 50).

The combination of the identity components 60 and the node components 70 allows any feature of the scenario transiting through the network 44, between the clients 50 and the network communication server 42 to have an identity used to synchronize the execution of the scenario on the plurality of clients 50.

The identity components 60 are configured to define an identity for each asset 64 of the scenario, for a specific session 90 and are configured to allow replication of the asset 64 on the plurality of clients 50 (i.e. replicating the position, rotation and properties of the asset 64 in the space 27 during execution of the scenario, on the plurality of clients).

In an embodiment, the identity defined by the identity component 60 for each asset 64 includes a unique asset identifier (ID) 62a associated to the corresponding asset 64 for the session 90. In an embodiment, the identity defined by the identity component 60 for each asset 64 can also include an authority identifier (ID) 63 identifying which of the clients 50 currently has control of the asset 64 within the scenario being executed, at a specific time within the session 90. It will therefore be understood that the authority ID 63 of the identity component 60 associated to an asset 64 can change during the session 90, while the unique asset ID 62a will remain the same for the entire session 90. In an embodiment, the unique asset ID 62a can be an integer, with the unique IDs being assigned incrementally for each asset 64, while the authority ID 63 can be an integer associated to one of the clients being part of the session 90. In view of the above, the use of the identity component results in every asset 64 of the scenario and identified by a reference node in the acyclic relation action graph 36 to have an identity generated and attached thereto.

The identity component 60 for each asset 64 also includes an asset container 80a which is used to define the data regarding the position, rotation and properties of the asset 64 in the space 27. The asset container 80a structure is designed to allow modularity for all types of assets 64 and can store a multitude of generic boxed objects 82 corresponding to various value types such as, for example and without being limitative, sbyte, byte, short, ushort, int, uint, long, ulong, float, double, and string. The container 80 therefore stores a multiplicity of boxed objects 82, which together define the asset data defining the position, rotation and/or properties of the asset 64 of the corresponding identity component 60 at a point in time, during the execution of the scenario. Using the asset container 80a, the identity component 60 is therefore able to store, send and receive data relative to the asset from the network 44.

Indeed, the asset container 80 is configured to be transmitted on the network 44, to the network communication server 42, to be forwarded to every client 50, in order to replicate the stored boxed objects 82 onto each one of the clients 50. The replication of the data from the asset containers 80a of the identity components 60 on all the client 50 allows each asset 64 to be replicated on the plurality of clients 50, and consequently allows the synchronization of the scenarios (synchronization of the display of the assets 64) on each one of the plurality of clients 50.

In view of the above, the identity components 60 allow each asset 64 to be replicated on all of the clients 50, in the corresponding session 90, upon occurrence of a change associated to the asset 64, for the client having the control of the asset 64. The replication occurs by synchronization of the corresponding identity component 60 on all of the clients 50. In other words, it is performed by transmission of the boxed objects 82 of the asset container 80a over the network and replication of the boxed objects 82 onto all of the client devices 50, for the asset identified with the unique asset ID 62a for which a change has occurred. Hence, each one of the clients 50 is provided with the most recent state of the asset 64 (provided by the corresponding boxed objects 82 of the asset container 80a of the identity component 60 thereof). The identity component 60 is used by the virtual, mixed or augmented reality application 54 to display the asset 64 in accordance with the most up to date state, within the scenario presented therein.

Similarly to identity components 60, the node components 70 are configured to define an identity for each node 30 of the acyclic relation action graph 36 and are configured to allow replication of node data for synchronization of the state of the node 30 on the plurality of clients 50.

The node components 70 are also configured to define an identity for each nodes 30 of the acyclic relation action graph 36 for a specific session 90, including a unique node identifier (ID) 62b associated the corresponding node 30 for the session 90 and which will remain the same for the entire session 90. In an embodiment, the unique IDs 62a, 62b of the node components 70 and identity components 60 are common such that there is no duplication between the unique IDs 62,a, 62b of the node components 70 and identity components 60.

The node component 70 for each node 30 also includes a node container 80b which is used to define the data regarding the node data required in order to replicate and synchronize the state of the node in the scenario. The node container 80b structure is similar to the above described asset container 80a structure thereof and operates similarly to allow modularity for all types of nodes 30. The node container 80b therefore stores a multiplicity of boxed objects 82, which together define the state of the node 30. Once again, using the node container 80b, the node component 70 is therefore able to store, send and receive data from the network 40, with the node container 80 being transmitted on the network 44, to the network communication server 42, to be forwarded to every client 50, in order to replicate the stored boxed objects 82 onto the client 50 for the synchronization of the state of the nodes 30.

Hence, the node component 70 allows each node 30 to be replicated on all of the clients 50, in the corresponding session 90, upon occurrence of a change in a state of the node 30. The replication occurs by synchronization of the corresponding node component 70 on all of the clients 50, through replication of the boxed objects 82 onto all of the client devices 50. Hence, each one of the clients 50 is provided with the most recent state of the node (provided by the corresponding boxed objects 82 of the node container 80b of the node component 70 thereof).

In view of the above, during the execution of a scenario, the node component 70 is configured to continuously define node data corresponding to a state the corresponding nodes 30 and to transmit the data on the network 44. As described above, the node data transmitted by the node component 70 is synchronized over the network 44 using the node containers 80b described above. In an embodiment, one of the value defined in the node container 80s of the node component 70 is a “isCompleted” value indicative of a node having completed its execution. Hence, the “isCompleted” value can be transmitted to the network communication server 42, to be forwarded to every client 50, using the node container 80b of the corresponding node component 70, when the corresponding node 30 has completed its execution.

Once an associated client 50 receives the node data from the node component 70, the received node data is acquired by the client API 56 of the virtual, mixed or augmented reality application 54 and the node data is imported in the corresponding node 30 executed in the virtual, mixed or augmented reality application 54. The virtual, mixed or augmented reality application 54 operates to allow each node 30 to process the node data corresponding therewith and to correspondingly automatically refresh the state thereof, based on how the specific node is operating.

In view of the above, when starting a multiplayer session 90, a node component 70 is associated to every node of the acyclic relation action graph 36 and an identity component 60 is associated to each asset 64 of the scenario. During execution of the scenario, the node component 70 and the identity component 60 are repeatedly replicated on all of the clients 50, upon occurrence of a change in a state of a node 30 or an asset 64, such that the current information relative to the nodes 30 and assets 64 is propagated to all of the nodes to allow the synchronized execution of the scenario.

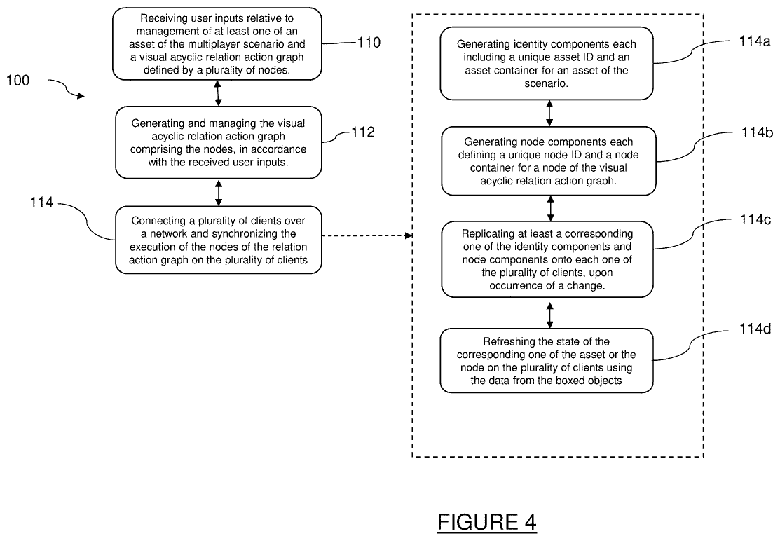

The system for generating and synchronously executing a multiplayer scenario, in one of a virtual, mixed and augmented reality environment having been described in details above, the corresponding method 100 will now be described in connection with FIG. 4.

The method 100, includes the initial step 110 of receiving user inputs relative to management of at least one of an asset of the multiplayer scenario and a visual acyclic relation action graph defined by a plurality of nodes and performed on a GUI. The user inputs are received through visual programming by the user, where the user provides data inputs relative to the arrangement of graphical symbols, icons and/or texts spatially on a plane, with each one of the graphical symbols, icons or text being used to define an input, an action, a connections and/or an output defining the program logic. As described in details above, the visual acyclic relation action graph defines the multiplayer scenarios in the one of the virtual, mixed and augmented reality environment.

As mentioned above, at this step, a creator creates or updates an asset of the scenario or an acyclic relation action graph through the GUI to define the interactive and immersive scenario, for example using drag-and-drop functionalities of the GUI.

In response to the user inputs generated by the creator using the input devices, the method comprises the further step 112 of generating and managing the visual acyclic relation action graph comprising the nodes, in accordance with the received user inputs.

The method also includes the step 114 of connecting the plurality of clients over a network, to synchronize the execution of the nodes of the acyclic relation action graph on the plurality of clients. Step 114 is in fact performed by a plurality of substeps, which include substep 114a of generating identity components each including a unique asset ID and an asset container for an asset of the scenario requiring replication on the plurality of clients for synchronized execution of the scenario thereon. As previously mentioned, the unique asset ID is associated to the corresponding asset for an entire session and the asset container stores boxed objects defining the data regarding the position, rotation and properties of the asset.

The method also includes the substep 114b of generating node components each defining a unique node ID and a node container for a node of the visual acyclic relation action graph which also requires replication on the plurality of clients for synchronized execution of the scenario thereon. Once again, as previously mentioned, the unique node ID is associated to the node for the entire session and the node container stores boxed objects containing the node data defining the state of the node.

The method further includes the substep 114c of replicating at least a corresponding one of the identity components and node components onto each one of the plurality of clients, upon occurrence of a change in a state of an asset or a node in the execution of the scenario on one of the clients. Hence, at this step, the identity components and node components are used to send the information relative to a node or an asset to all of the clients, in order to broadcast a change having occurred with one of the corresponding asset or node on one client, such that the execution of the scenario can be synchronized on all clients. In an embodiment, this is performed by transmitting the container of the corresponding one of the identity components and node components on the network and forwarding the container to every clients.

In an embodiment, the method further includes substep 114d of refreshing the state of the corresponding one of the asset or the node on the plurality of clients using the data from the boxed objects of the replicated corresponding one of the identity components and node components (i.e. in accordance with the replicated identity components and node components containing the boxed objects thereof).

As mentioned above, the identity components can each further include an authority identifier identifying the client currently having control of the asset within the scenario being executed. Hence, the method can include the step of replicating the identity components of the clients being identified as having control of the asset within the scenario onto the other clients, upon occurrence of a change in the state of the asset in the execution of the scenario on the client currently having control of the asset within the scenario.

In an embodiment, the method further includes executing the scenario in the one of the virtual, mixed or augmented reality environment for each one of the clients using the virtual, mixed or augmented reality application described above and stored in a memory of the clients. The scenario is executed by the virtual, mixed or augmented reality application using the data from the replicated identity components and the node components. In an embodiment, the node data from the node components is imported into the corresponding nodes executed in the virtual, mixed or augmented reality application and the processing of the node data corresponding with the node can be performed in accordance with operation of the specific node by the virtual, mixed or augmented reality application.

It should be appreciated by those skilled in the art that any block diagrams herein represent conceptual views of illustrative circuitry embodying the principles disclosed herein. Similarly, it will be appreciated that any flow charts and transmission diagrams, and the like, represent various processes which may be substantially represented in computer readable medium and so executed by a computer or processor, whether or not such computer or processor is explicitly shown.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention could be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A system for generating and synchronously executing a multiplayer scenario, in one of a virtual, mixed and augmented reality environment, the system comprising:
a visual programming module including a graphical user interface allowing generation and management of at least one of an asset of a scenario and a visual acyclic relation action graph defined by a plurality of nodes, the at least one of the asset and the visual acyclic relation action graph being generated and managed in response to user inputs received from an input device of a computing device displaying the graphical user interface, the visual acyclic relation action graph defining the multiplayer scenarios in the one of the virtual, mixed and augmented reality environment;
a network module configured to connect a plurality of clients over a network for synchronized execution of the nodes of the acyclic relation action graph on the plurality of clients, the network module operating using a network protocol comprising:
an identity component including a unique asset identifier and an asset container for each asset of the multiplayer scenario requiring replication on the plurality of clients for synchronized execution of the scenario thereon, the unique asset identifier being associated to the corresponding asset for an entire session, the asset container storing boxed objects defining the data regarding the position, rotation and properties of the asset, the identity component being replicable on the plurality of clients;
a node component defining a unique node identifier and a node container for each node of the visual acyclic relation action graph which also requires replication on the plurality of clients for synchronized execution of the scenario thereon, the unique node identifier being associated to the node for the entire session, the node container storing boxed objects containing the node data defining the state of the node, the node component being replicable on the plurality of clients.

2. The system of claim 1, wherein the identity component further includes an authority identifier identifying which one of the clients currently has control of the asset within the scenario being executed.

3. The system of claim 1, wherein the network module is implemented using a network communication server in data communication with each one of the plurality of clients over the network in a client-server architecture.

4. The system of claim 3, wherein each one of the plurality of clients has stored in a memory thereof a virtual, mixed or augmented reality application configured to execute the scenario in the one of the virtual, mixed or augmented reality environment.

5. The system of claim 4, wherein the node data from the node component of each node is imported into the corresponding node executed in the virtual, mixed or augmented reality application, each node processing the node data corresponding therewith in accordance with a specific operation of the node.

6. The system of claim 5, wherein the network communication server communicates data via a network server application programming interface and the virtual reality, mixed or augmented reality application stored in the memory of each client communicates data via a client application programming interface.

7. The system of claim 1, wherein the network module and the network protocol thereof are configured to allow the synchronized execution of the scenario on the plurality of clients connected via each one of an offline network and an online network.

8. The system of claim 1, wherein the visual acyclic relation action graph comprises a plurality of visual acyclic relation action subgraphs, the system allowing at least a subset of the plurality of visual acyclic relation action subgraphs to be executed simultaneously.

9. A computer implemented method for generating and synchronously executing a multiplayer scenario, in one of a virtual, mixed and augmented reality environment, the method comprising the steps of:
receiving user inputs relative to management of at least one of an asset of the multiplayer scenario and a visual acyclic relation action graph defined by a plurality of nodes and being performed on a graphical user interface using visual programming, the visual acyclic relation action graph defining the multiplayer scenarios in the one of the virtual, mixed and augmented reality environment;
generating and managing the visual acyclic relation action graph comprising the nodes, in accordance with the received user inputs;
connecting a plurality of clients over a network and synchronizing the execution of the nodes of the relation action graph on the plurality of clients, this step including the sub steps of:
generating identity components each including a unique asset identifier and an asset container for an asset of the multiplayer scenario requiring replication on the plurality of clients for synchronized execution of the scenario thereon, the unique asset identifier being associated to the corresponding asset for an entire session and the asset container storing boxed objects defining the data regarding the position, rotation and properties of the asset;
generating node components each defining a unique node identifier and a node container for a node of the visual acyclic relation action graph which also requires replication on the plurality of clients for synchronized execution of the scenario thereon, the unique node identifier being associated to the node for the entire session, the node container storing boxed objects containing the node data defining the state of the node;
replicating at least a corresponding one of the identity components and node components onto each one of the plurality of clients, upon occurrence of a change in a state of an asset or a node in the execution of the scenario on one of the clients;
refreshing the state of the corresponding one of the asset or the node on the plurality of clients using the data from the boxed objects of the replicated corresponding one of the identity components and node components.

10. The method of claim 9, wherein the identity components each further include an authority identifier identifying the client currently having control of the asset within the execution of the scenario being executed and wherein the step of replicating at least a corresponding one of the identity components and node components onto each one of the plurality of clients, upon occurrence of a change in a state of an asset or a node in the execution of the scenario on one of the clients comprises replicating the identity components of the client being identified as having control of the asset within the scenario onto the other clients, upon occurrence of a change in the state of the asset in the execution of the scenario on the client currently having control of the asset within the scenario.

11. The method of claim 9, further comprising the step of executing the scenario in the one of the virtual, mixed or augmented reality environment for each one of the clients using a virtual, mixed or augmented reality application stored in a memory thereof and using the data from the replicated identity components and the node components for execution of the scenario.

12. The method of claim 11, wherein the node data from the node components is imported into the corresponding nodes executed in the virtual, mixed or augmented reality application, the method comprising the step of processing the node data corresponding therewith in accordance with operation of the specific node.

13. The method of claim 9, wherein the step of replicating at least a corresponding one of the identity components and node components onto each one of the plurality of clients, upon occurrence of a change in a state of an asset or a node in the execution of the scenario on one of the clients comprises transmitting the container of the corresponding one of the identity components and node components on the network and forwarding the container to every clients.

14. The method of claim 9, wherein the step of connecting a plurality of clients over a network and synchronizing the execution of the nodes of the relation action graph on the plurality of clients comprises allowing data communication between the plurality of clients and a network communication server over a network via each one of an offline network and an online network.

15. A non-transitory computer-readable medium having instructions stored thereon that, when executed by a processor, perform the steps of the method of claim 9.

16. A non-transitory computer-readable medium having instructions stored thereon that, when executed by a processor, perform the steps of the method of claim 10.

17. A non-transitory computer-readable medium having instructions stored thereon that, when executed by a processor, perform the steps of the method of claim 11.

18. A non-transitory computer-readable medium having instructions stored thereon that, when executed by a processor, perform the steps of the method of claim 12.

19. A non-transitory computer-readable medium having instructions stored thereon that, when executed by a processor, perform the steps of the method of claim 13.

20. A non-transitory computer-readable medium having instructions stored thereon that, when executed by a processor, perform the steps of the method of claim 14.
